(19) United States
(12) Patent Application Publication
(10) Pub. No.: US 2026/0288186 A1
(43) Pub. Date: Sep. 24, 2026

(54) CURRENT STEERING IN VOLTAGE REGULATORS

(71) Applicant: Intel Corporation, Santa Clara, CA (US)

(72) Inventors: Amit K. Jain, Sherwood, OR (US); Yihong Yang, Portland, OR (US); Mauricio Aguilar Salas, Heredia (CR); Fabrice Paillet, Portland, OR (US)

(21) Appl. No.: 19/086,693

(22) Filed: Mar. 21, 2025

(51) Int. Cl. G05F 1/59; G05F 1/46; G05F 1/575; G06F 1/26

(52) U.S. Cl. CPC G05F 1/59; G05F 1/468; G05F 1/575; G06F 1/26

(57) ABSTRACT

Embodiments herein relate to electronically linked, e.g., ganged, voltage regulators (VRs) coupled to processor cores or other power-consuming circuits. Circuits are provided to minimize loss mechanisms when the load in the cores is not uniform by optimally distributing current between the VRs. In one approach, a reference current (Iref) is set differently for the different VRs. In another approach, a number of turned-on power transistors (Nfet) is set differently for the different VRs. In another approach, the two above approaches are combined. Changes to Nfet can be made on a faster time scale than changes to Iref. The load in the cores can be determined by monitoring drain voltages, or a difference between drain and source voltages, of power transistors of the VRs.

### BACKGROUND

Computing devices often rely on voltage regulators (VRs) to obtain power. A VR is an electrical circuit which can accept a direct current (DC) input and generate a DC output of a different voltage, e.g., a lower voltage, usually by high-frequency switching of inductive and/or capacitive elements. The lower voltage can be used by various components in the computing device, such as a Universal Serial Bus (USB) interface, memory such as dynamic random access memory (DRAM) and processing resources such as a central processing unit (CPU). However, it is challenging to supply power efficiently.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts a circuit 100 including first and second cores (Core1 and Core2, respectively) powered by primary and secondary voltage regulators (VRp and VRs, respectively), with plots of voltage and current for uniform and non-uniform loads in the cores, in accordance with various embodiments.

FIG. 2A depicts an example circuit 200 which implements the first and second cores and primary and secondary voltage regulators of FIG. 1, in accordance with various embodiments.

FIG. 2B depicts an example implementation of circuits 220p1 and 230p1 in the driver 220p and current mirror 230p, respectively, of FIG. 2A, in accordance with various embodiments.

FIG. 2C depicts an example implementation of the set of power transistors 210p of FIG. 2A, in accordance with various embodiments.

FIG. 3 depicts an example circuit 300 which represents the operation of the circuit 200 of FIG. 2A, in accordance with various embodiments.

FIG. 4 depicts an example circuit 400 which implements the first and second cores and primary and secondary voltage regulators of FIG. 1 with dynamic modulation of a reference current Iref, in accordance with various embodiments.

FIG. 5 depicts an example circuit 500 which implements the first and second cores and primary and secondary voltage regulators of FIG. 1 with (a) dynamic modulation of Nfet, a number of field-effect transistors (FETs) or (b) dynamic modulation of both Iref and Nfet, in accordance with various embodiments.

FIG. 6 depicts an example circuit 600 which implements the dynamic modulation of Iref, consistent with FIGS. 4 and 5, with sensing of a difference between source and drain voltages of p-type FETs (pFETs) in VRp and VRs, in accordance with various embodiments.

FIG. 7 depicts an example circuit 700 which implements the dynamic modulation of Iref, consistent with FIG. 5, with sensing of drain voltages, but not source voltages, of pFETs in VRp and VRs, in accordance with various embodiments.

FIG. 8 depict example plots showing the operation of the circuit 200 of FIG. 2A, which does not use current steering, in accordance with various embodiments.

FIG. 9 depict example plots showing the operation of the circuit 400 of FIG. 4, which uses current steering, in accordance with various embodiments.

FIG. 10 depict example plots showing the operation of the circuit 500 of FIG. 5, with dynamic modulation of the number of FETs, in accordance with various embodiments.

FIG. 11 depicts an example circuit 1100 which implements the dynamic modulation of the number of FETs, consistent with FIG. 5, with sensing of a difference between source and drain voltages of pFETs in VRp and VRs, in accordance with various embodiments.

FIG. 12 depicts an example circuit 1200 which implements the dynamic modulation of the number of FETs, consistent with FIG. 5, with sensing of drain voltages, but not source voltages, of pFETs in VRp and VRs, in accordance with various embodiments.

FIG. 13 depicts an example circuit 1300 which implements the dynamic modulation of both Nfet and Iref with high-pass and low-pass filters 1350 and 1360, respectively, consistent with FIG. 5, in accordance with various embodiments.

FIG. 14 depicts example plots showing the operation of the circuit 1300 of FIG. 13, in accordance with various embodiments.

FIG. 15 depicts an example circuit 1500 which depicts power loss mechanisms in the first and second cores and primary and secondary voltage regulators of FIG. 1, in accordance with various embodiments.

FIG. 16 depicts plots of power loss versus VRp/VRs current distribution in the circuit 1500 of FIG. 15, in accordance with various embodiments.

FIG. 17 depicts plots of Vsd,p/Vsd,s versus VRp/VRs current distribution in the circuit 1500 of FIG. 15, in accordance with various embodiments.

FIG. 18 depicts a plot of the on-die load line resistance, Rs2xtor, versus VRp/VRs current distribution in the circuit 1500 of FIG. 15, in accordance with various embodiments.

FIG. 19 depicts plots of power loss versus Core1/Core2 current distribution in the circuit 1500 of FIG. 15, in accordance with various embodiments.

FIG. 20A depicts a circuit 2000 including first and second cores (Core1 and Core2, respectively) powered by primary and secondary voltage regulators (VRp and VRs, respectively), with plots 2050 and 2060 of current with and without current steering, respectively, in accordance with various embodiments.

FIG. 20B depicts equations which represent the operation of the circuit 2000 of FIG. 20A, in accordance with various embodiments.

FIG. 21 depicts plots 2150 and 2160 of power loss versus Core1/Core2 current distribution with and without current steering, respectively, consistent with FIG. 20, in accordance with various embodiments.

FIG. 22 depicts an example circuit 2200 representing a VR output domain, in accordance with various embodiments.

FIG. 23 depicts plots 2350 and 2360 of frequency versus voltage for ideal and actual cases, respectively, in accordance with various embodiments.

FIG. 24 depicts a circuit 2400 including first and second cores (Core1 and Core2, respectively) powered by primary and secondary voltage regulators (VRp and VRs, respectively), with plots 2450 and 2560 of current with and without current steering, respectively, in accordance with various embodiments.

FIG. 25 depicts plots 2550 and 2560 of resistance versus Core1/Core2 current distribution with and without current steering, respectively, consistent with FIG. 24, in accordance with various embodiments.

FIG. 26 illustrates an example of components that may be present in a computing system 2650 for implementing the techniques (e.g., operations, processes, methods, and methodologies) described herein.

### DETAILED DESCRIPTION

As mentioned at the outset, various challenges are encountered in supplying power efficiently to a computing device.

In some cases, voltage regulators (VRs) are ganged across spatially distributed load domains. A ganged VR circuit refers to a group of VRs that are electronically linked together to operate as a single unit, meaning they all adjust their output essentially simultaneously based on a shared control signal. A ganged VR circuit is often used to provide precise and coordinated voltage regulation across large domains or high currents not available in a single instance of a voltage regulator including in computation-intensive integrated circuits. Advantages include increased power handling capacity, improved stability due to redundancy and current distribution.

In one approach, the ganging is of primary and secondary VRs for first and second processor cores, Core1 and Core2, e.g., primary and secondary processor cores, respectively.

Ganging of voltage regulators across spatially distributed load domains requires current regulation mode for each ganged VR instance, where current from each instance is set to follow a reference current in proportion to its total current capability. In the case of two identical linear voltage regulators (LVR) ganged to supply a load domain from the edges, e.g., to a dual-core module, the input-to-output voltage drop across each LVR (Vsd, source-to-drain voltage, which determines its efficiency) varies with the spatial distribution of the load current. With a uniform load distribution, LVR1 and LVR2 supply equal currents, Vsd1=Vsd2 and the system has a minimum power loss. Vsd1 and Vsd2 refer to the source-to-drain voltage of power transistors in the primary and secondary VRs, respectively.

With only one core active (e.g., Core1) and the other idle, half of the current travels from the far LVR (LVR2) across Core2 to Core1. This results in three loss mechanisms: I²R loss from current coming from LVR2 across Core2 and feeding Core1; Vsd1>Vsd2, which implies a higher loss in LVR1; and a degraded voltage-frequency (V-f) curve due to higher on-die load line loss between the regulator feedback sense point and the logic transistor. Thus, the ganging mechanism with current sharing introduces losses that increase as the load distribution with respect to the individual LVR instance locations becomes less uniform. This loss is significant, e.g., several Watts.

The solutions provided herein address the above and other issues. In one aspect, the solutions include circuits which modify the ganging controls to minimize the above-mentioned loss mechanisms by optimally distributing current between the VR instances.

The solutions can modulate current sharing between VRs with the goal of equalizing voltages across the VRs, which in turn reduces power overhead with ganging. One approach involves dynamically modulating the reference current (Iref) of the VRs. Another approach involves dynamically modulating the strength of the VRs in terms of the number (Nfet) of turned-on power transistors. Another approach involves dynamically modulating both the reference current and the VR strength, with reference current changes acting at a relatively slow time scale and strength (Nfet) changes acting at a relatively fast time scale. The load non-uniformity in the cores can be determined by monitoring drain voltages, or a difference between drain and source voltages, of power transistors of the VRs.

The solutions provide a number of advantages, including minimizing power consumption by reducing I²R losses, VR circuit losses, and improving the V-f curve. The loss reduction can be automatically used for computation within the total power budget of a central processing unit (CPU), for example, and result in increases in performance and performance-per-Watt.

These and other features will be further apparent in view of the following discussion.

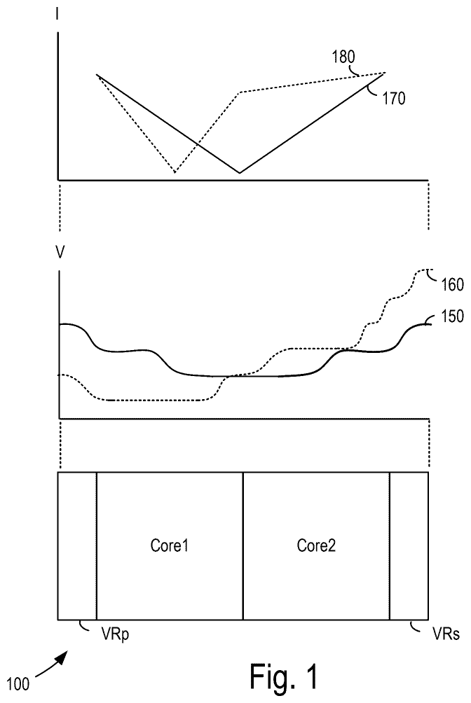

FIG. 1 depicts a circuit 100 including first and second cores (Core1 and Core2, respectively) powered by primary and secondary voltage regulators (VRp and VRs, respectively), with plots of voltage and current for uniform and non-uniform loads in the cores, in accordance with various embodiments. The cores, which may be processor cores, for example, share the same ganged output domain and include various circuits. VRp is at one end of the set of cores, e.g., at the left-hand side, adjacent to Core1, and VRs is at the other, opposing end of the set of cores, e.g., at the right-hand side, adjacent to VRp. The VRs can both supply power to both cores.

A plot 150 depicts a voltage (V) at different positions in the cores for the case of a uniform load in the cores, e.g., with both cores active. The horizontal axis depicts a horizontal position in the cores. In this case, the voltage across the cores is relatively uniform, and slightly lower at the boundary between the cores, which is a furthest point from the VRs, and higher at points which are closer to the VRs. Similarly, a plot 170 depicts a current (I) flowing across at different positions in the cores for the case of a uniform load in the cores. The current across the cores is lowest at the boundary between the cores, which is a furthest point from the VRs, and highest at points which are closer to the VRs.

A plot 160 depicts a voltage (V) at different positions in the cores for the case of a non-uniform load in the cores, e.g., with Core1 active and Core2 idle. In this case, the voltage across the cores is highest at points which are closest to VRs and lowest at points which are closest to VRp. Similarly, a plot 180 depicts a current (I) at different positions in the cores for the case of the non-uniform load. The current across the cores is lowest at a midpoint of Core1 and highest at points which are closer to the VRs.

Note that while various examples herein depict ganging of two VRs in a dual-core module (circuit 100), it is possible to gang more than two VRs. Also, the number of cores can vary. The dual-core module is an example of a multi-core or other multi-logic domain module. The same principles apply to other VR types such as switched-capacitor VR (SCVR), buck, boost, and buck-boost converter that are ganged together to supply a spatially distributed load.

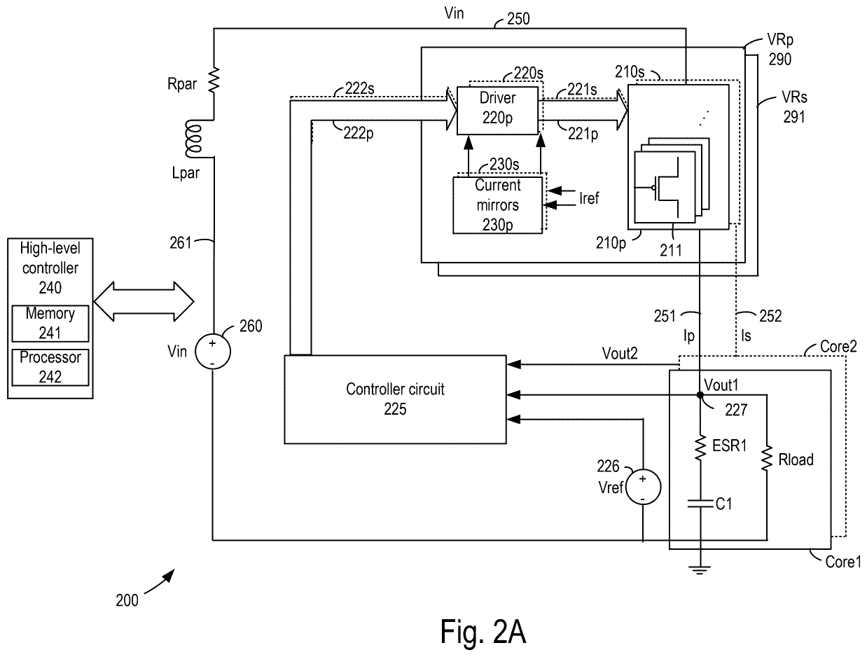

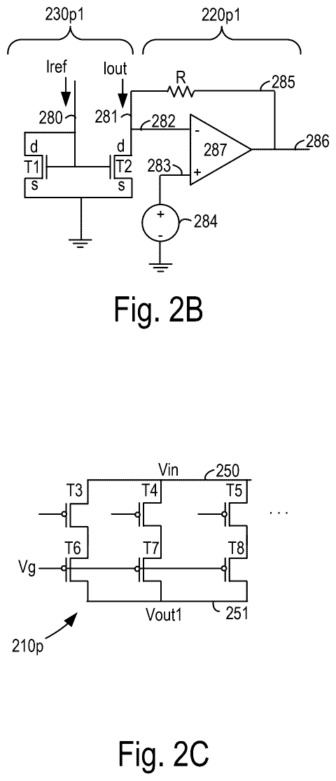

FIG. 2A depicts an example circuit 200 which implements the first and second cores and primary and secondary voltage regulators of FIG. 1, in accordance with various embodiments. The circuit includes VRp 290 and VRs 291, which has a similar configuration as VRp.

VRp includes a set of power transistors 210p which are pFETs (e.g., p-type metal-oxide-semiconductor field-effect transistors or MOSFETs) in this example. An example pFET 211 is depicted. A specified number of the power transistors can be turned on based on enable signals from a driver 220p on a path 221p. The driver 220p is coupled to one or more current mirrors 230p which receive a reference current, Iref, from a high-level controller 240. The high-level controller 240 may include a memory 241 to store instructions and a processor 242 to execute the instructions to communicate with the circuit 200.

Similarly, VRs includes a set of power transistors 210s. A specified number of the power transistors can be turned on based on enable signals from a driver 220s on a path 221s. The driver is coupled to one or more current mirrors 230s, which receive the same reference current, Iref, as in VRp, in this example.

The drivers can control gate voltages Vg of the power transistors to provide desired source-to-gate voltages Vsgp and Vsgs of the set of power transistors for VRp and VRs, respectively. The source voltage may be Vin on a path 250 and the drain voltage may be Vout on a path 251 or 252. Vin is provided by a voltage source 260 via a path 261 which has an impedance simply denoted by an inductor Lpar and an equivalent series resistance Rpar.

The drivers 220p and 220s receive enable signals on paths 222p and 222s, respectively, from a local controller circuit 225. In one approach, the drivers receive the same enable signal. The controller circuit 225 in turn receives a reference voltage, Vref, from a voltage source 226, an output voltage Vout1 at a node 227 in Core1, and an output voltage Vout2 at a corresponding node in Core2. VRp and VRs output currents Ip and Is, respectively, on paths 251 and 252, respectively. The controller circuit 225 may include proportional integral (PI) and non-linear controllers.

Core1 is represented by ESR1 in series with a capacitor C1, and a load resistance Rload. Core2 has a similar configuration as Core1.

The circuit 200 provides a simplified block diagram of a Digital Linear Voltage Regulator (DLVR) which regulates output voltage by controlling the number (Nfet) of pFETs required to supply the load current. To ensure pFET reliability, the current through each pFET can be regulated to a reference value (Iref) by controlling the source-to-gate voltage Vsg. With current-per-pEFT constant, a relatively larger number of pFETs are turned on at high load, while a relatively small number of pFETs are turned on at low load.

FIG. 2B depicts an example implementation of circuits 220p1 and 230p1 in the driver 220p and current mirror 230p, respectively, of FIG. 2A, in accordance with various embodiments. A current mirror 220p1 includes an input path 280 which receives Iref and a mirrored output path 281 which provides Iout=Iref. In this example, the input and output paths includes respective n-type MOSFETs T1 and T2 with drain (d) terminals and grounded source(s) terminals. The drain of the transistor T2 is coupled to an inverting input 282 of an amplifier 287, while a voltage source 284 at an offset voltage is coupled to a non-inverting input 283 of the amplifier. An output node 286 of the amplifier is coupled to a feedback path 285 which includes a resistor R. The output node can be coupled to control gates of the power transistors.

FIG. 2C depicts an example implementation of the set of power transistors 210p of FIG. 2A, in accordance with various embodiments. A set of switching transistors T3, T4, T5, . . . such as pMOSFETs are in parallel and coupled to the input path 250 at Vin. Each of these transistors can be switched on or off by the driver 220p based on enable signals and Nfet, which indicates the number of power transistors to turn on. A set of power transistors T6, T7, T8, . . . are in parallel and coupled to the switching transistors and the output path 251 at Vout1, and receive a common control gate voltage Vg, in one possible implementation. These transistors can be turned on relatively more strongly (to become relatively more conductive) when Iref is relatively higher.

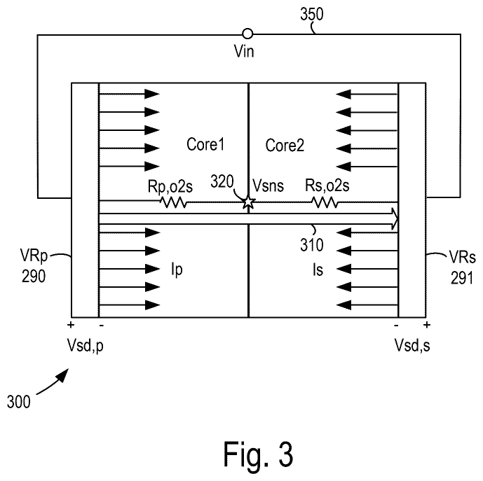

FIG. 3 depicts an example circuit 300 which represents the operation of the circuit 200 of FIG. 2A, in accordance with various embodiments. A path 350 connects the input voltage Vin to VRp and VRs. Current (Ip) flows from VRp to the cores, and current (Is) flows from VRs to the cores. Enable signals are provided from VRp to VRs on a path 310. A sense voltage, Vsns, is obtained at a sense point 320 between the cores for use in a feedback control loop to ensure that Vsns=Vref. Rp,o2s and Rs,o2s represent an effective resistance of Core1 and Core2, respectively.

The circuit 300 depicts a dual-core module (DCM) with a ganged-DLVR implementation. The physical layouts of Core1 and Core2 are identical but horizontally mirrored, in this example implementation. Two similar DLVR instances can be placed on either side of the DCM. The primary DLVR instance (VRp) determines Nfet for voltage regulation and transmits it to the secondary DLVR (VRs), while the per-FET current is controlled independently in each instance to a predetermined Iref that minimizes power loss. The same Nfet and Iref values are used by both the DLVRs so they share the load current equally, in this approach.

To maintain highest efficiency, the VR input voltage is set to the minimum value needed to meet the I*R drop and pFET voltage dropout under the highest current expected. With two VRs in parallel, the input voltage is determined as the maximum of the voltage needed by either one to ensure proper operation of the VR. The voltage drops can be calculated as follows. Rₒ₂ₛ is an effective resistance calculated as an I*R drop from the VR local outputs to the sense point 320 divided by total load (Iₜₒₜ) for a particular load distribution across the two cores. In a dual-core module implementation, Rₒ₂ₛ can be calculated from VRp and VRs as Rp,o2s and R_{s,o2s} respectively. If the loads in both cores, I_{core1} and I_{core2}, are equal, the distribution is the same and both VRs supply the same current, and the two Rₒ₂ₛ values are equal.

However, if the distributions in Core1 and Core 2 are not the same, the two Rₒ₂ₛ values are not equal. Specifically, if the load within Core1 is higher than that in Core2, R_{p,o2s} is lower than R_{s,o2s}. If the load within Core2 is higher than that in Core1, R_{p,o2s} is higher than R_{s,o2s}. To cover all possibilities, max (R_{p,o2s}, R_{s,o2s}) is chosen to calculate the required VR input voltage. Note that the maximum input voltage (Vin) is determined over all cases of load distribution with the worst case being one core at highest activity while the other core is idle:

$${V}_{in} = {V}_{sns} + max ( {R}_{p , o 2 s} , {R}_{s , o 2 s} ) * {I}_{tot , max} + {V}_{do}$$

where V_{do} is minimum dropout voltage needed for the pFET to operate correctly.
I_{tot,max} is a maximum value of Iₜₒₜ.

Once the input voltage is determined, for a real load with total current Iₜₒₜ the resulting voltages across the two VRs are:

$${V}_{sd , p} = {V}_{in} - ( {V}_{sns} + {R}_{p , o 2 s} * {I}_{tot} ) = max ( {R}_{p , o 2 s} , {R}_{s , o 2 s} ) * {I}_{tot , max} - {R}_{p , o 2 s} * {I}_{tot} + {V}_{do}$$

$${V}_{sd , s} = {V}_{in} - ( {V}_{sns} + {R}_{s , o 2 s} * {I}_{tot} ) = max ( {R}_{p , o 2 s} , {R}_{s , o 2 s} ) * {I}_{tot , max} - {R}_{s , o 2 s} * {I}_{tot} + {V}_{do}$$

If R_{s,o2s}>R_{p,o2s}, the VR input voltage is set to Vᵢₙ=Vₛₙₛ+R_{s,o2s}*I_{tot, max}+V_{do} and the actual voltage drops across the FETs are:

$${V}_{sd , p} = {R}_{s , o 2 s} * {I}_{tot , max} - {R}_{p , o 2 s} * {I}_{tot} + {V}_{do}$$

$${V}_{sd , s} = {R}_{s , o 2 s} * {I}_{tot , max} - {R}_{s , o 2 s} * {I}_{tot} + {V}_{do}$$

$$and$$

$${ΔV}_{sd} = {V}_{sd , p} - {V}_{sd , s} = ( {R}_{s , o 2 s} - {R}_{s , o 2 s} ) * {I}_{tot}$$

The total power loss in both VRs is:

$${P}_{LVR} = {P}_{LVRp} + {P}_{LVRs} = {V}_{sd , p} * \frac{{I}_{tot}}{2} + {V}_{sds} * \frac{{I}_{tot}}{2} = ( {R}_{s , o 2 s} * {I}_{tot , max} - ( {R}_{p , o 2 s} + {R}_{s , o 2 s} ) * \frac{{I}_{tot}}{2} + {V}_{do} ) * {I}_{tot}$$

Additionally, if I_{tot, max}=Iₜₒₜ, P_{LVR}=V_{do}*Iₜₒₜ+|ΔV_{sd}|*Iₜₒₜ/2.

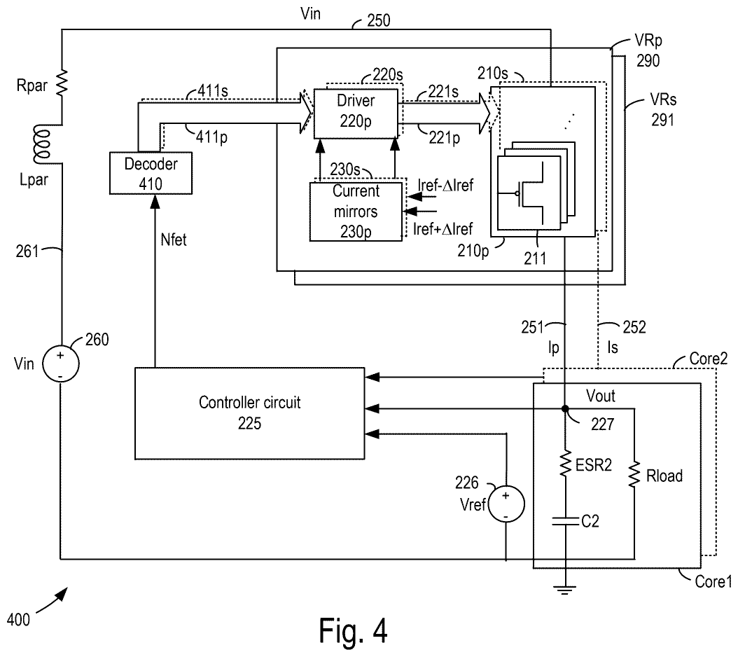

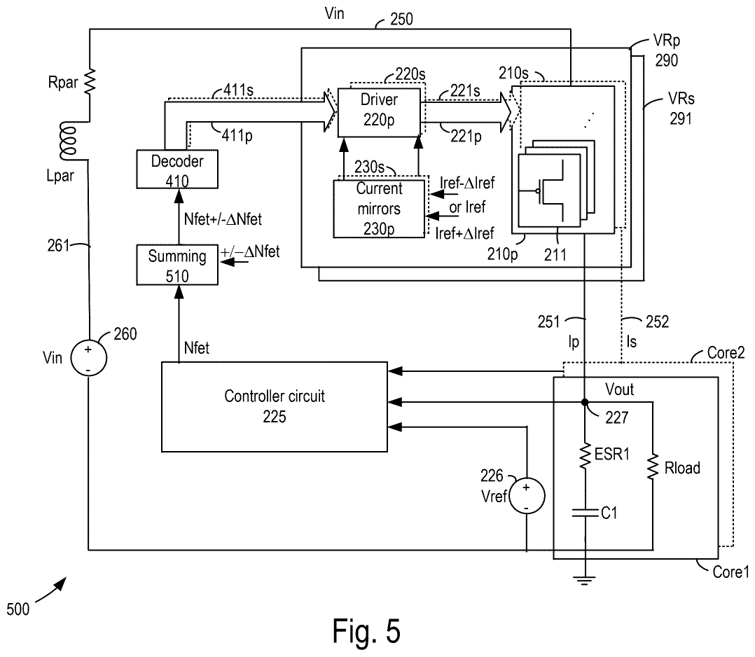

Accordingly, power loss within the VRs can be minimized by minimizing |ΔV_{sd}|. Besides the loss in the VR itself, minimizing |ΔV_{sd}| also minimizes the resistive loss in the power grid over the load domain, and significantly reduces the on-die load line loss past the sense location, as discussed further below. Three example mechanisms are discussed below in connection with FIGS. 4 and 5 to minimize |ΔV_{sd}|.

FIG. 4 depicts an example circuit 400 which implements the first and second cores and primary and secondary voltage regulators of FIG. 1 with dynamic modulation of a reference current Iref, in accordance with various embodiments. The circuit 400 is similar to the circuit 200 but includes a decoder 410 which receives Nfet from the control circuit 225 and provides corresponding enable signals on paths 411p and 411s to the drivers 220p and 220s. Additionally, the current mirrors 230p and 230s receive Iref,p=Iref+ΔIref and Iref,s=Iref−ΔIref, respectively, instead of just Iref, so that Vsgp and Vsgs may be different. ΔIref can be a positive or negative adjustment, and is an adjustment to Iref to minimize |ΔV_{sd}|. This notation indicates Iref,p is increased by ΔIref when Iref,s is decreased by ΔIref, and vice-versa.

In one approach, Vg is decreased and Vsg is increased when Iref is increased, and the power transistor are pFETs. A lower Vg turns on the power transistors more strongly so that their current output is increased.

FIG. 5 depicts an example circuit 500 which implements the first and second cores and primary and secondary voltage regulators of FIG. 1 with (a) dynamic modulation of Nfet, a number of field-effect transistors (FETs) or (b) dynamic modulation of both Iref and Nfet, in accordance with various embodiments. The circuit 500 is similar to the circuit 400 but includes a summing circuit 510 which receives +/−ΔNfet. The summing circuit provides Nfet+/−ΔNfet to the decoder 410 which in turn provides corresponding enable signals on paths 411p and 411s to the drivers 220p and 220s. ΔNfet can be a positive or negative adjustment to Nfet to minimize |ΔV_{sd}|. In one approach, Nfet,p=Nfet+ΔNfet and Nfet,s=Nfet−ΔNfet. This notation indicates Nfet,p is increased by ΔNfet when Nfet,s is decreased by ΔNfet, and vice-versa. Nfet,p is the number of power transistors to turn on in VRp, and Nfet,s is the number of power transistors to turn on in VRs.

For case (a), the current mirrors 230p and 230s can both receive Iref, similar to FIG. 2A, so that dynamic modulation of Iref is not provided. For case (b), the current mirrors 230p and 230s receive Iref,p=Iref+ΔIref and Iref,s=Iref-ΔIref, respectively, so that dynamic modulation of Iref is also provided.

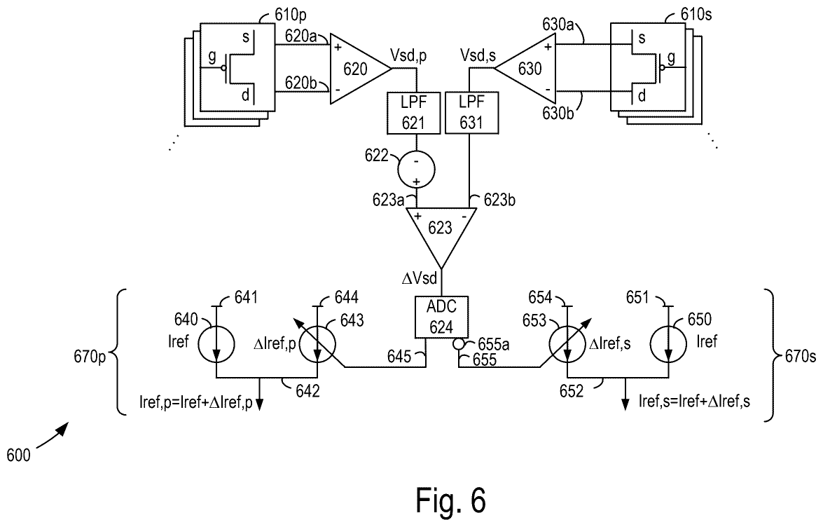

FIG. 6 depicts an example circuit 600 which implements the dynamic modulation of Iref, consistent with FIGS. 4 and 5, with sensing of a difference between source and drain voltages of p-type FETs (pFETs) in VRp and VRs, in accordance with various embodiments. The VRp includes a set of power transistors 610p which each have a source(s), drain (d) and gate (g) terminal. An amplifier 620 includes a non-inverting input 620a coupled to the source terminals and an inverting input 620b coupled to the drain terminals. An output of the amplifier, V_{sd,p}, is provided to a low-pass filter (LPF) 621. The output of the LPF is coupled to a non-inverting input 623a of a comparison amplifier 623 (an operational amplifier) by an input offset voltage source 622. The input offset voltage is a voltage that is applied between the two input terminals of the comparison amplifier 623.

The amplifiers 620, 630 and 623 are examples of first, second and third amplifiers, respectively.

Similarly, VRs includes a set of power transistors 610s which each have a source (s), drain (d) and gate (g) terminal. An amplifier 630 includes a non-inverting input 630a coupled to the source terminals and an inverting input 630b coupled to the drain terminals. An output of the amplifier, Vsd,s, is provided to a LPF 631. The output of the LPF 631 is coupled to an inverting input 623b of the comparison amplifier 623.

ΔVsd, an output of the comparison amplifier 623, is coupled to an input of an analog-to-digital converter (ADC) 624. The ADC provides digital values on first and second output paths 645 and 655, respectively, for controlling respective current sources 670p and 670s. The output 655 of the ADC is inverted as indicated by the inverter 655a and is therefore the negative of the output 645.

In particular, the first and second output paths are coupled to variable current sources 643 and 653, respectively, in VRp and VRs, respectively. In VRp, the variable current source 643 is biased at a power supply node 644 and provides a current adjustment ΔIref,p to a node 642. A current source 640 is biased at a power supply node 641 and provides Iref to the node 642, so that the current at the node 642 is Iref,p=Iref+ΔIref,p.

In VRs, the variable current source 653 is biased at a power supply node 654 and provides a current adjustment ΔIref,s to a node 652. A current source 650 is biased at a power supply node 651 and provides Iref to the node 652, so that the current at the node 652 is Iref,s=Iref+ΔIref,s.

In this approach, the source-to-drain voltage (V_{sd}) of both VRs is measured using differential amplifiers and low-pass filtered. The filtered signals are compared using a differential amplifier and the resulting ΔV_{sd} is digitized to an ΔIref that modifies the original I_{ref} for both VRs. If V_{sd,p}>V_{sd,s}ΔI_{ref,p}>0, and ΔI_{ref,s}<0 so that the primary VR supplies more current while the secondary DLVR starts supplying less current: Iₛ<Iₜₒₜ/2<Iₚ.

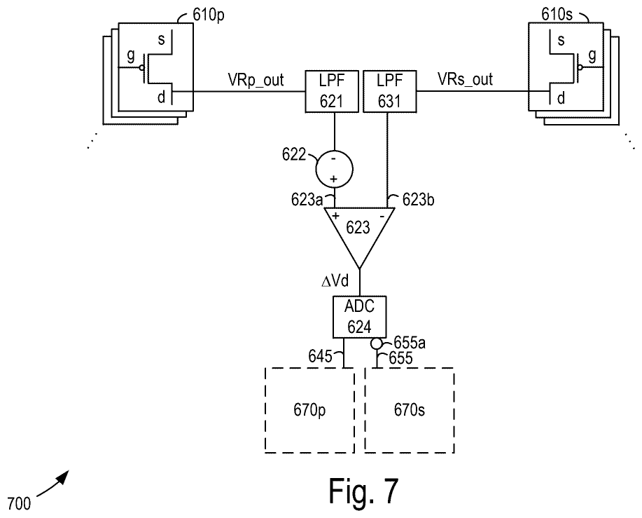

If the voltage at the two LVR inputs are the same, the scheme can be simplified to sense the LVR drain voltages alone, as shown in FIG. 7.

In FIGS. 6, 7, 11 and 12, some or all of the components depicted except the sets of power transistors may be provided in the high-level controller 240.

FIG. 7 depicts an example circuit 700 which implements the dynamic modulation of Iref, consistent with FIG. 5, with sensing of drain voltages, but not source voltages, of pFETs in VRp and VRs, in accordance with various embodiments. This circuit 700 differs from the circuit 600 in that the amplifiers 620 and 630 are not used. Instead, the drain voltage VRp_out (Vd,p) of the set of transistors 610p is provided to the LPF 621, and the drain voltage VRs_out (Vd,s) of the set of transistors 610s is provided to the LPF 631. The output of the amplifier 623 is ΔVd. The ADC provides digital values on first and second output paths 645 and 655, respectively, for controlling respective current sources 670p and 670s, as in FIG. 6.

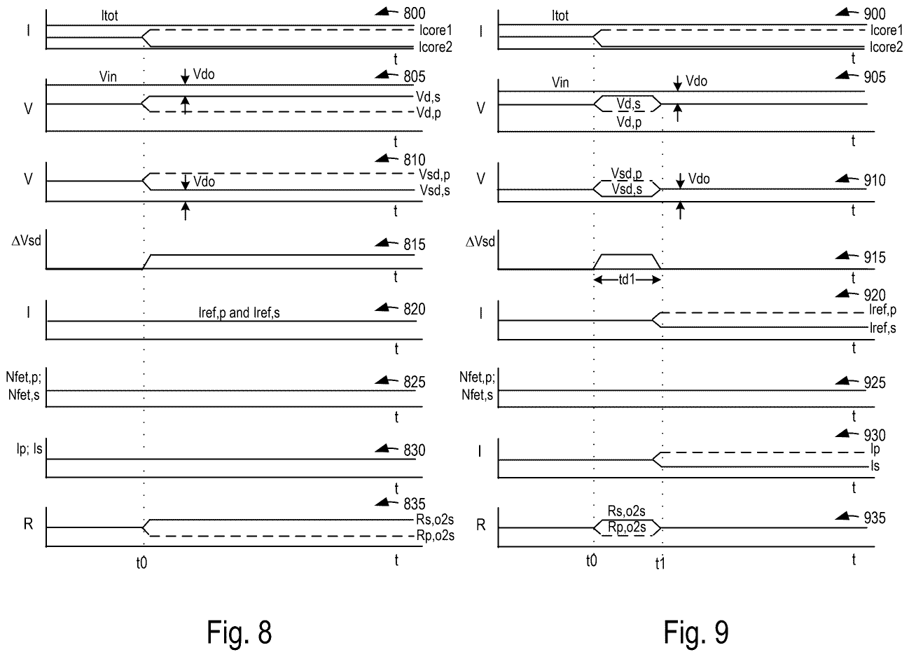

FIG. 8 depict example plots showing the operation of the circuit 200 of FIG. 2A, which does not use current steering (dynamic modulation of Iref or Nfet), in accordance with various embodiments. In this comparative case, there is no dynamic adjustment of Iref or Nfet.

Plots 800 depict Iₜₒₜ, the total current consumption in both cores of a dual-core module, Icore1, the current consumption in Core1, and Icore2, the current consumption in Core2. Initially, Icore1=Icore2 so that Itot is allocated equally between the cores. At t0, Icore1 increases and I_{core2} decreases so that the allocation is no longer equal.

The plots 805 depict Vin, Vd,p and Vd,s. Vd,s increases with Icore1, and Vd,p decreases with Icore2. Vdo is a difference between Vin and the increased level of Vd,s.

The plots 810 depict Vsd,p and Vsd,s. Vsd,p increases with Icore1, and Vsd,s decreases with Icore2.

The plot 815 depicts ΔVsd, which increases with Icore1 at t0.

The plots 820 depict Iref,p and Iref,s, which are constant.

The plots 825 depict Nfet,p and Nfet,s, which are constant and equal.

The plots 830 depict Ip and Is, which are constant and equal.

The plots 835 depict the resistances Rs,o2s and Rp,o2s. Rp,o2s increases with Icore1, and Rp,o2s decreases with Icore1.

Without current steering, max (R_{p,o2s}, R_{s,o2s}). Iₜₒₜ is used to determine the input voltage as discussed above. With current steering, avg (R_{p,o2s}, R_{s,o2s}). Iₜₒₜ is used to determine the input voltage. In the waveforms, the load changes from equal identically distributed currents across each core to an increase in I_{core1} and an essentially simultaneous decrease in I_{core2} at t0.

When the I_{core1}=I_{core2}, V_{d,p}=V_{d,s}, and hence the dropout voltages across the two VRs are the same: V_{sd,p}=V_{sd,s}. Under this condition, R_{s,o2s}=R_{p,o2s}. When I_{core1}>I_{core2} without current steering, V_{d,p}<V_{d,s}, and R_{s,o2s}>R_{p,o2s}. Note that proper operation of the VR circuit without current steering requires the input voltage to be chosen for the worst-case load distribution, i.e., max (R_{p,o2s}, R_{s,o2s}). Iₜₒₜ. In the case of a dual-core module, this happens when one core (Core 1) has highest activity and the other (Core2) is idle, max (R_{p,o2s}, R_{s,o2s})=R_{s,o2s}, V_{sd,s}=V_{do} while V_{sd,p}>V_{do}. With current steering, V_{sd,p} can be tuned to be equal to V_{sd,s} by increasing I_{ref,p} and decreasing I_{ref,s}. So, the primary VR will provide more current than the secondary VR (Iₚ>Iₛ) and R_{p,o2s}=R_{s,o2s}=avg(R_{p,o2s}, R_{s,o2s}). Thus, the dropout voltage of both VRs can be minimized irrespective of the currents in the two cores, thereby minimizing power loss.

Due to the low-pass filter and the current loop response, there will be some latency from detecting |ΔV_{sd}| to Iref changes that minimize |ΔV_{sd}|. Moreover, depending on the low-pass filter and load current transients, this technique may degrade output voltage transients. This aspect is addressed with an essentially simultaneous modulation of Nfet and Iref.

FIG. 9 depict example plots showing the operation of the circuit 400 of FIG. 4, which uses current steering, in accordance with various embodiments. In this case, there is a dynamic adjustment of Iref.

Plots 900 depicts Itot, Icore1 and Icore2. At t0, Icore1 increases and Icore2 decreases, as in FIG. 8.

The plots 905 depict Vin, Vd,p and Vd,s. At t0, Vd,s increases with Icore1 and Vd,p decreases with Icore2. Once the Iref modulation takes effect at t1, Vd,s decreases and Vd,p increases returning back to their initial level at t0.

The plots 910 depict Vsd,p and Vsd,s. At t0, Vsd,p increases with Icore1 and Vsd,s decreases with Icore2. Once the Iref modulation takes effect at t1, Vsd,p decreases and Vsd,s increases returning back to their initial level at t0.

The plot 915 depicts ΔVsd, which increases with Icore1 at t0, then decreases back to its initial level at t1. A time period from t0 to t1 is a delay, td1. As mentioned, power loss within the VRs can be advantageously minimized by minimizing |ΔV_{sd}|.

The plots 920 depict Iref,p and Iref,s. At t1, Iref,p increases and Iref,s decreases due to the dynamic adjustment process. These changes trigger the corresponding changes in plots 905, 910 and 915.

The plots 925 depict Nfet,p and Nfet,s, which are constant and equal.

The plots 930 depict Ip and Is. At t1, Ip increases with Iref,p and Is decreases with Iref,s.

The plots 935 depict Rs,o2s and Rp,o2s. At t0, Rs,o2s increases with Icore1 and Rp,o2s decreases with Icore2. At t1, Rs,o2s decreases and Rp,o2s increases returning back to their initial level at t0.

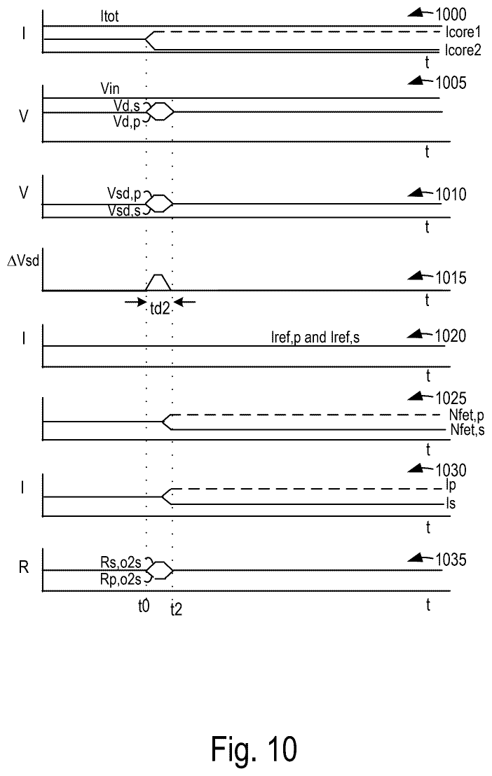

FIG. 10 depict example plots showing the operation of the circuit 500 of FIG. 5, with dynamic modulation of the number of FETs, in accordance with various embodiments.

Plots 1000 depict Itot, Icore1 and Icore2. At t0, Icore1 increases and Icore2 decreases, as in FIGS. 8 and 9.

The plots 1005 depict Vin, Vd,p and Vd,s. At t0, Vd,s increases with Icore1 and Vd,p decreases with Icore2. At t2, Vd,s decreases and Vd,p increases returning back to their initial level at t0.

The plots 1010 depict Vsd,p and Vsd,s. At t0, Vsd,p increases with Icore1 and Vsd,s decreases with Icore2. At t2, Vsd,p decreases and Vsd,s increases returning back to their initial level at t0.

The plot 1015 depicts ΔVsd, which increases with Icore1 at t0, then decreases back to its initial level at t2. A time period from t0 to t2 is a delay, td2, which is less than td1.

The plots 1020 depict Iref,p and Iref,s, which are constants.

The plots 1025 depict Nfet,p and Nfet,s. At t2, Nfet,p increases and Nfet,s decreases.

The plots 1030 depict Ip and Is. At t2, Ip increases with Nfet,p and Is decreases with Nfet,s.

The plots 1035 depict Rs,o2s and Rp,o2s. At t0, Rs,o2s increases with Icore1 and Rp,o2s decreases with Icore2. At t2, Rs,o2s decreases and Rp,o2s increases returning back to their initial level at t0.

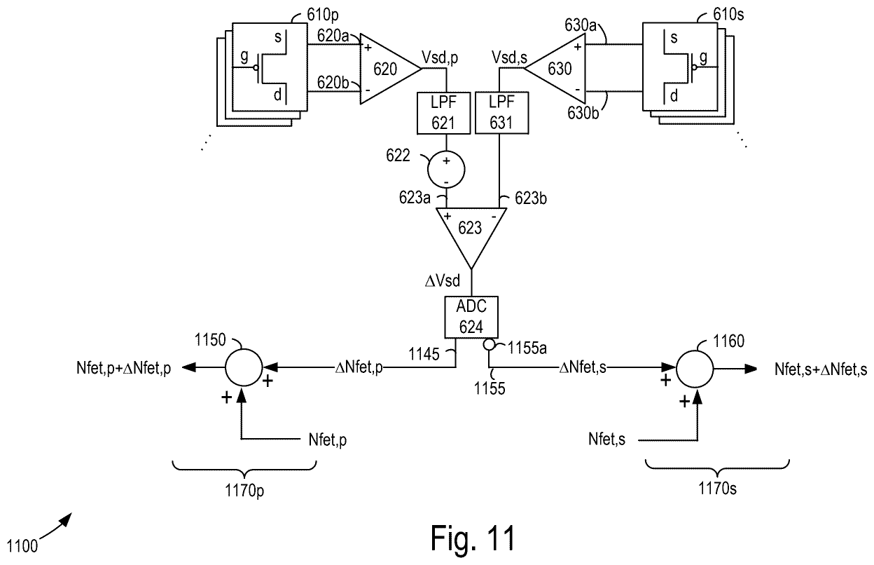

FIG. 11 depicts an example circuit 1100 which implements the dynamic modulation of the number of FETs, consistent with FIG. 5, with sensing of a difference between source and drain voltages of pFETs in VRp and VRs, in accordance with various embodiments. Like-numbered components of FIG. 6 are repeated. In contrast to FIG. 6, the ADC provides digital values on first and second paths 1145 and 1155, respectively, for controlling Nfet calculation circuits 1170p and 1170s, respectively. In particular, ΔNfet,p is provided on path 1145, and ΔNfet,s is provided on path 1155. The output 1155 of the ADC 624 is inverted at the inverter 1155a and is therefore negative of the output 1145. In VRp, an adder/subtracter 1150 receives ΔNfet,p and Nfet,p as inputs and provides Nfet,p+ΔNfet,p as an output. Similarly, in VRs, an adder/subtracter 1160 receives ΔNfet,s and Nfet,s as inputs and provides Nfet,s+ΔNfet,s as an output.

The circuit 1100 provides dynamic modulation of the number of turned on FETs (NFET) of each VR to minimize |ΔV_{sd}|. The ΔV_{ds} sensing remains the same as with the technique for dynamic modulation of Iref. With I_{core1}>I_{core2}, without any current steering technique, V_{sd,p}>V_{sd,s}. This technique then sets ΔN_{FET,p}>0, ΔN_{FET,s}<0 so that a larger number of FETs are enabled in the primary VR and fewer FETs are enabled in the secondary VR. With this modulation, the primary VR supplies more current while the secondary VR supplies less current: Iₛ<Iₜₒₜ/2<Iₚ. The final result is the same as with the reference current modulation technique. The difference is that the change in N_{FET} causes a direct change in the VR current while the reference current modulation technique has a lag due to the control mechanism for current regulation.

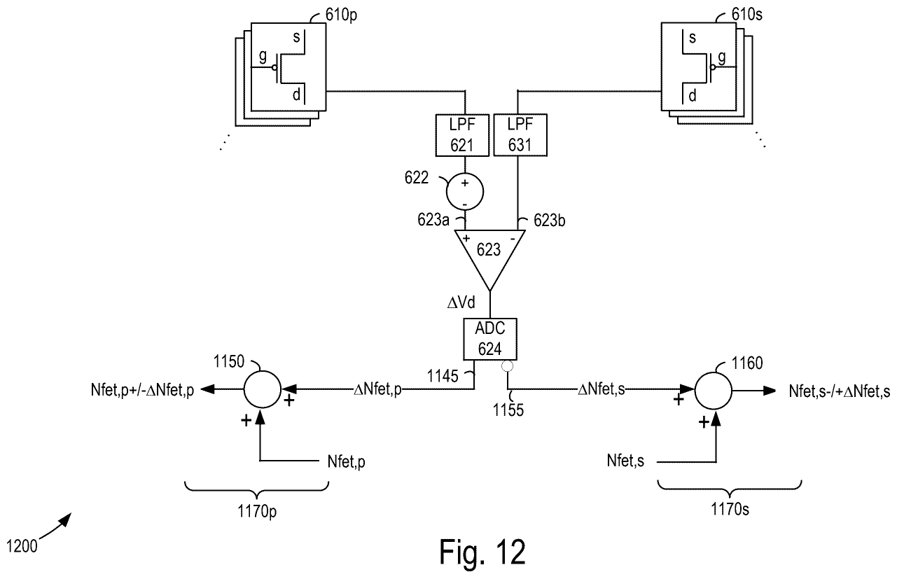

FIG. 12 depicts an example circuit 1200 which implements the dynamic modulation of the number of FETs, consistent with FIG. 5, with sensing of drain voltages, but not source voltages, of pFETs in VRp and VRs, in accordance with various embodiments. This circuit 1200 differs from the circuit 1100 in that the amplifiers 620 and 630 are not used. Instead, the drain voltage VRp_out (Vd,p) of the set of transistors 610p is provided to the LPF 621, and the drain voltage VRs_out (Vd,s) of the set of transistors 610s is provided to the LPF 631. The output of the amplifier 623 is ΔVd.

Note that modulation of both reference current and Nfet can also be provided using the circuits of 6, 7, 11 and 12, for example.

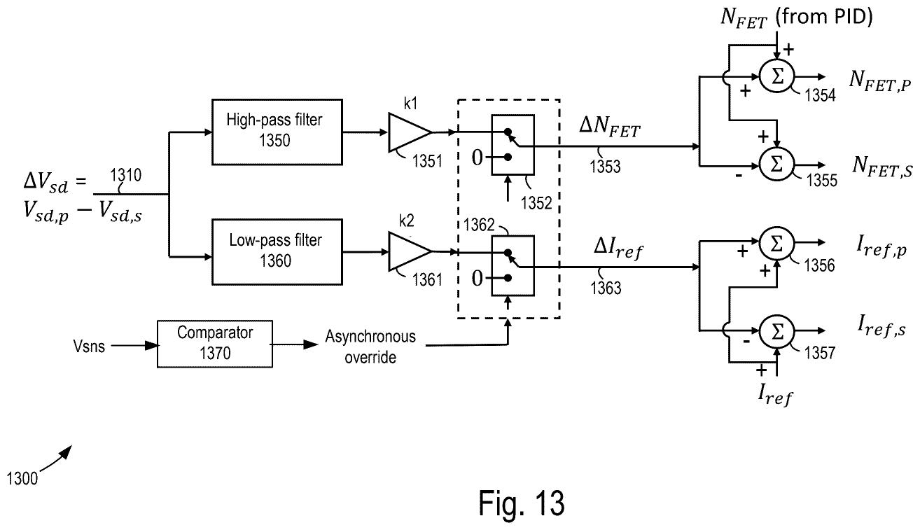

FIG. 13 depicts an example circuit 1300 which implements the dynamic modulation of both Nfet and Iref with high-pass and low-pass filters 1350 and 1360, respectively, consistent with FIG. 5, in accordance with various embodiments. The low-pass filter is used to adjust Iref relatively slowly, with a relatively long delay (see, e.g., td1 in FIG. 9) while the high-pass filter is used to adjust Nfet relatively quickly, with a relatively short delay (see, e.g., td2<td1 in FIG. 10).

In particular, the filters receive ΔVsd=Vsd,p−Vsd,s at a node 1310. The output of the high-pass filter is scaled by a factor k1 at a scaling circuit 1351, and the output of the low-pass filter is scaled by a factor k2 at a scaling circuit 1361. The scaled output, ΔNfet, is passed by a multiplexer 1352, based on the value of an asynchronous override signal, to a path 1353 which is an input to summing circuits 1354 and 1355. When the asynchronous override signal is asserted, a zero value is instead passed to the path 1353. Similarly, the scaled output, ΔIref, is passed by a multiplexer 1362, based on the value of the asynchronous override signal, to a path 1363 which is an input to summing circuits 1356 and 1357. When the asynchronous override signal is asserted, a zero value is instead passed to the path 1363.

The summing circuit 1354 outputs Nfet,p=Nfet+ΔNfet. Nfet can be provided by a proportional-integral-derivative (PID) controller. The summing circuit 1355 outputs Nfet,s=−Nfet−ΔNfet. The summing circuit 1356 outputs Iref,p=Iref+ΔIref. The summing circuit 1357 outputs Iref,s=Iref−ΔIref.

The circuit 1300 provides both FET count and Reference Current Modulation IDEA at the same time. The circuit uses FET count (N_{FET}) to balance V_{sd} in the shorter duration since N_{FET} can be changed very quickly. This is done by filtering the ΔV_{sd} signal with the high-pass filter and using the scaled output as a ΔN_{FET} Signal that adds/subtracts from the N_{FET} coming from the PID controller. Similarly, the reference current changes are made by a ΔI_{ref} signal, which is generated from a low-pass filtered and scaled version of ΔV_{sd}, so that the change in I_{ref} happen at a slower rate than the changes in Nfet. Finally, there is an asynchronous override that resets both ΔN_{FET} and ΔI_{ref} to zero for both VRs. The asynchronous override is activated by large excursions in output voltage when non-linear control mechanism(s) may override the PID controller output. A comparator 1370 may compare Vsns to a threshold to determine whether to assert the asynchronous override. The override may be asserted when Vsns falls below some threshold voltage, for example.

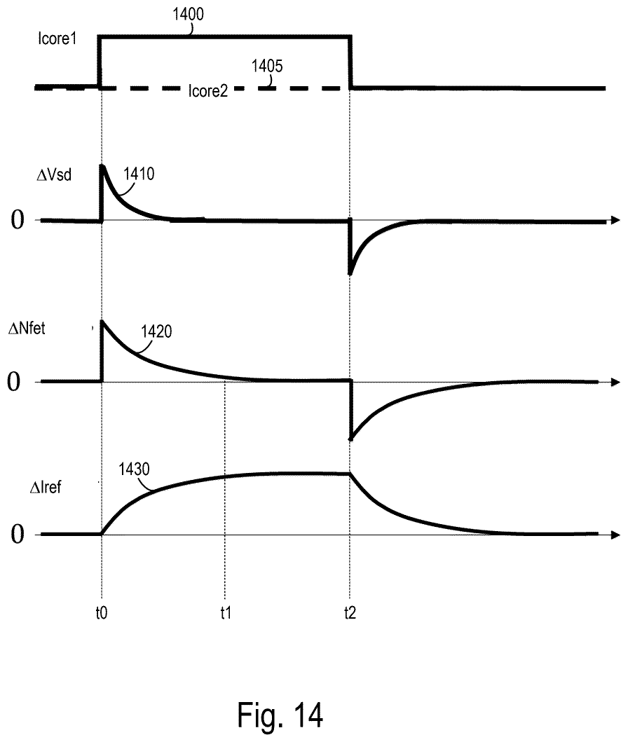

Conceptual waveforms with different currents in the two cores are shown in FIG. 14. This hybrid scheme: (a) accounts for the relatively slow response of the current regulation mechanisms by using N_{FET} as the short duration control variable to balance the two V_{sd} S; (b) avoids scenarios where N_{FET} of one VR gets maxed out to the highest count (due to a low value of I_{ref}); and (c) addresses high di/dt transients, when the VRs need to supply the maximum possible current to minimize the voltage droop magnitude and duration, with the override mechanism.

The technique minimizes |Vsd1−Vsd2| and does not change the total Nfet or the baseline Iref. Rather, it changes the distribution of Nfet (e.g., Nfet,p and Nfet,s) and Iref (e.g., Iref1 or Iref,p and Iref2 or Iref,s) between the two VR instances. The net control gain of the ganged dual VR configuration remains the same. Thus, there is no stability concern introduced by these control loops.

FIG. 14 depicts example plots showing the operation of the circuit 1300 of FIG. 13, in accordance with various embodiments. Plots 1400 and 1405 depict Icore1 and Icore2, respectively, plot 1410 depicts ΔVsd, plot 1420 depicts ΔNfet, and plot 1430 depicts ΔIref. At t0, Icore1 increase while Icore2 remains constant. This triggers a quick increase in ΔNfet and a slower increase in ΔIref. ΔVsd increases quickly and then advantageously returns to zero to minimize power loss, as discussed. At t1, ΔNfet has decreased to almost zero while ΔIref has increased to almost its peak level.

At t2, Icore1 decreases back to its initial level. This triggers a quick decrease in ΔNfet and a slower decrease in ΔIref. ΔVsd decreases quickly and then returns to zero. ΔNfet also returns to zero.

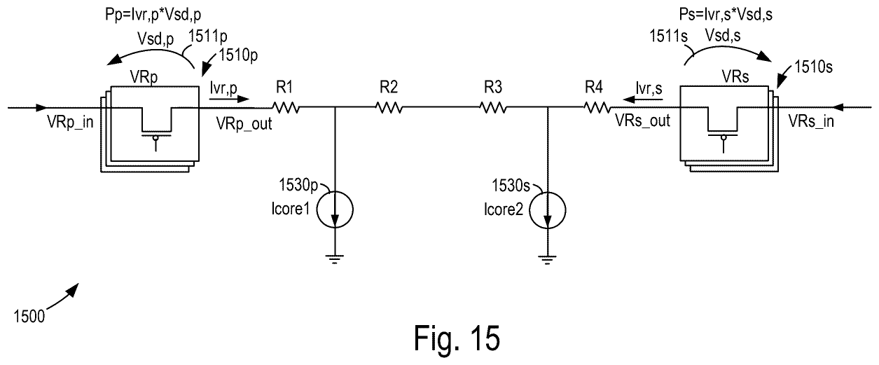

FIG. 15 depicts an example circuit 1500 which depicts power loss mechanisms in the first and second cores and primary and secondary voltage regulators of FIG. 1, in accordance with various embodiments. The solutions provided herein provide advantages including a reduction of Ivr*Vsd losses in the VR circuits, a reduction of I²R losses in the conductors that carry the current from the VRs to the loads, and an improvement in the voltage frequency (V-f) curve. The mechanisms in a power delivery scheme with a dual-core module and identical VRs at the edges ganged together to power both cores, are depicted in the circuit 1500.

The circuit 1500 includes a set of power transistors 1510p in VRp which receives VRp_in as an input and provides Ivr,p and VRp_out as outputs. Similarly, a set of power transistors 1510s in VRs receives VRs_in as an input and provides Ivr,s and VRs_out as outputs. Series resistors R1, R2, R3 and R4 that represent the output domain resistance are coupled between the sets of power transistors, while current sinks 1530p and 1530s represent Icore1 and Icore2, respectively. The current sink 1530p is coupled between R1 and R2, and the current sink 1530s is coupled between R3 and R4.

An arrow 1511p indicates that a source-to-drain voltage of the set of power transistors 1510p is Vsd,p. A corresponding power is Pp=Ivr,p*Vsd,p.

An arrow 1511s indicates that a source-to-drain voltage of the set of power transistors 1510s is Vsd,s. A corresponding power is Ps=Ivr,s*Vsd,s.

Each of the resistors also has an associated power consumption of I²R.

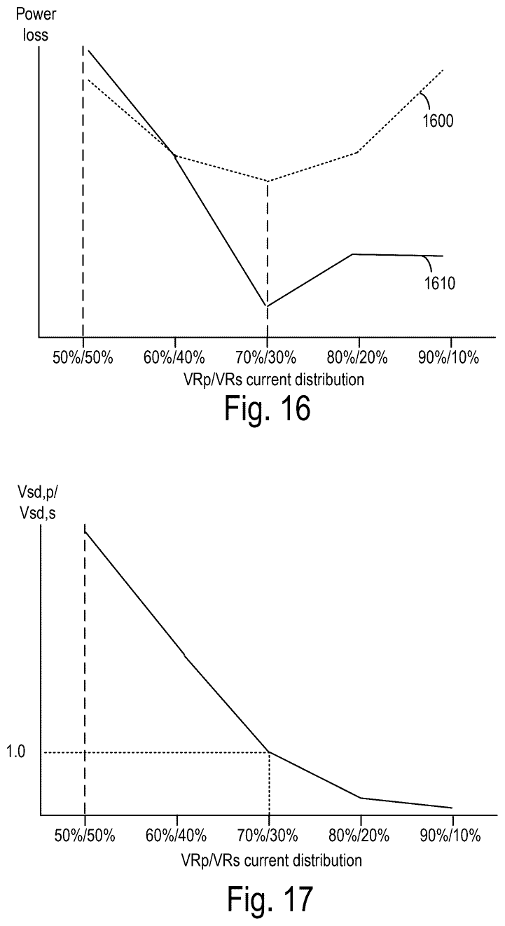

FIG. 16 depicts plots of power loss versus VRp/VRs current distribution in the circuit 1500 of FIG. 15, in accordance with various embodiments.

The benefits of the modulation mechanism which relies on reducing the ΔV_{sd} among the primary and secondary VRs (V_{sd,p}/V_{sd,s}=1) are depicted where, for a fixed uneven load (chosen in this example to be I_{Core1}=45A, I_{Core2}=5A), the current distribution between the primary and secondary VRs is swept from equal current (I_{LVR,p}=25A, I_{LVR,s}=25A) to 90%/10% (I_{LVR,p}=45A, I_{LVR,s}=5A). This is simulated using a power delivery network (PDN) with typical parameters. The same PDN is used for the results of FIGS. 16-19.

In FIGS. 16-18, the 50%/50% point corresponds to no current steering and the 70%/30% point corresponds to a current steering optimization point, where the power loss is a minimum. The power loss increases when VRp/VRs current ratio decreases below, or increases above, 70%/30%.

The plot 1600 represents the power loss of the through conductors and the plot 1610 represents the power loss of the VR circuits. When the two V_{sd} values are equal (at the 70%/30% point in FIG. 17), this results in the optimal current steering point. This point not only ensures that the VR circuit losses are minimum but also the lowest conductor power loss.

FIG. 17 depicts plots of Vsd,p/Vsd,s versus VRp/VRs current distribution in the circuit 1500 of FIG. 15, in accordance with various embodiments. The Vsd,p/Vsd,s=1 corresponds to the current steering optimization point (VRp/VRs current ratio=70%/30%). Vsd,p/Vsd,s decreases as VRp/VRs current ratio increases.

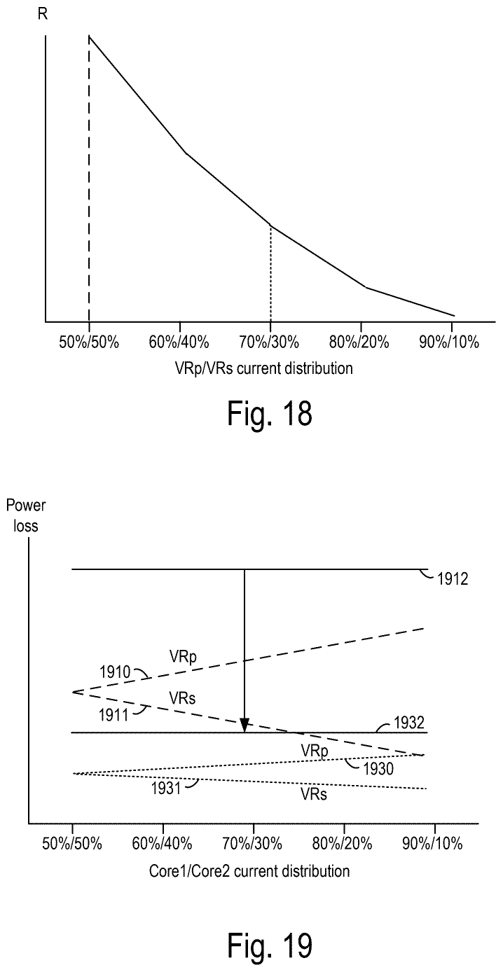

FIG. 18 depicts a plot of the on-die load line resistance, Rs2xtor, versus VRp/VRs current distribution in the circuit 1500 of FIG. 15, in accordance with various embodiments. Rs2xtor decreases as VRp/VRs increases.

The direct current (DC) on-die load line resistance (Rₛ₂ₓₜₒᵣ) is significantly reduced (by 66% in the example) at the proposed optimal point of 70%/30%. Note that Rₛ₂ₓₜₒᵣ is not at the minimum possible value but is close to optimal since the conductor and VR losses start increasing if the VR current distribution is made more unequal.

FIG. 19 depicts plots of power loss versus Core1/Core2 current distribution in the circuit 1500 of FIG. 15, in accordance with various embodiments. Plots 1910 and 1911 depict the power loss for VRp and VRs, respectively, without current steering, and plot 1912 depicts the corresponding total VR power loss, which is the sum of the two plots. Plots 1930 and 1931 depict the power loss for VRp and VRs, respectively, with current steering, and plot 1932 depicts the corresponding total VR power loss, which is the sum of the two plots.

These plots compare the reduction of the power loss in the VR circuits with and without current steering as the current distribution between Core1 and Core2 changes. This scenario assumes that the whole module consumes 50A, and the current is swept starting at equal current consumed by Core1/Core2 (25A each) and finishing at an extreme case of 90% Core1/10% Core2 (45A/5A).

With the current steering, as V_{sd} equalizes, the I_{VR}*V_{sd} loss reduces, leading to an overall power loss reduction of 67% reduction. As discussed, the reason is that with current steering, the requested voltage, e.g., as expressed by a voltage identification (VID) can be set using the average value of R_{p,o2s} and R_{s,o2s} instead of their maximum value.

The VID refers to a voltage level requested by a processor or other integrated circuit from a VR. The VID is a digital signal sent from the processor to the VR, which then adjusts the supply voltage accordingly.

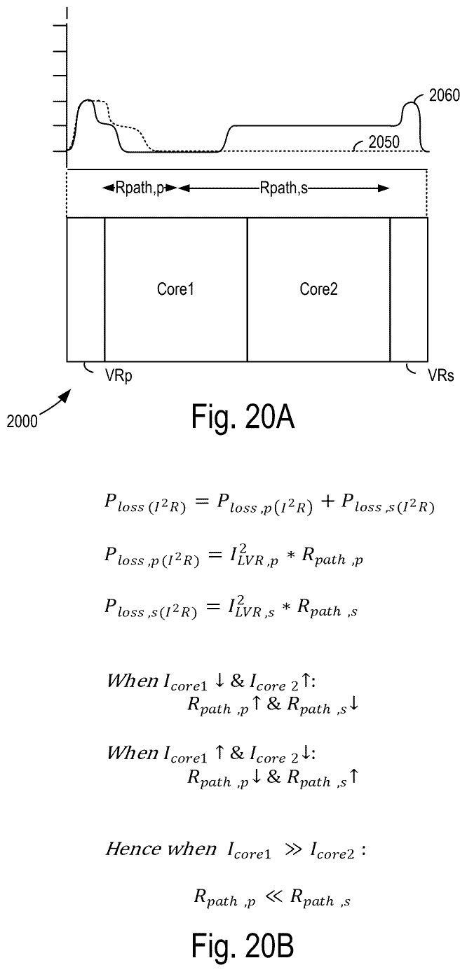

FIG. 20A depicts a circuit 2000 including first and second cores (Core1 and Core2, respectively) powered by primary and secondary voltage regulators (VRp and VRs, respectively), with plots 2050 and 2060 of current with and without current steering, respectively, in accordance with various embodiments. The techniques provided herein reduce I²R losses for an uneven load (e.g., ICore1=45A, ICore2=5A). In this case, since the primary VR is next to the active load, the resistive path to the load Rpath,p will be relatively small. On the other hand, with the secondary VR far from the active load, the resistive path Rpath,s will be relatively large. Note that these resistive path resistances (Rpath,p; Rpath,s) are not physical resistors but parameters that represents the voltage drop caused by the current flowing from the source (VR) to the load (Cores). Rpath,p and Rpath,s are not constant and change with the current distribution in the VRs and the Cores.

Without the techniques provided herein, each VR will deliver an equal amount of current, forcing half of the total current consumed by the two cores to flow through the high resistive path (Rpath,s) leading to higher I²R losses. In an example of this case, without current steering, IVR,p=IVR,s=25A and Vsd,p>Vsd,s with ICore1=45A and ICore2=5A.

With the mechanisms proposed, the primary VR current will increase (35A in the example) and the secondary VR current will decrease (15A in the example) to minimize ΔVsd. This will force more current through the lower resistive path (Rpath,p) and less current through the higher resistive path (Rpath,s) leading to overall lower I²R losses. In an example of this case, with current steering, IVR,p(35A)>IVR,s(15A) and Vsd,p=Vsd,s with ICore1=45A and ICore2=5A.

The power loss Ploss(I²R) with no current steering is greater than the power loss with current steering by 33%.

FIG. 20B depicts equations which represent the operation of the circuit 2000 of FIG. 20A, in accordance with various embodiments. The equations refer to the I²R power loss for the PDN and to a change in the path resistance for VRp and VRs when Icore1 and Icore2 change. When Icore decreases, Rpath increases and vice-versa. When Icore1>>Icore2, Rpath,p<<Rpath,s and vice-versa.

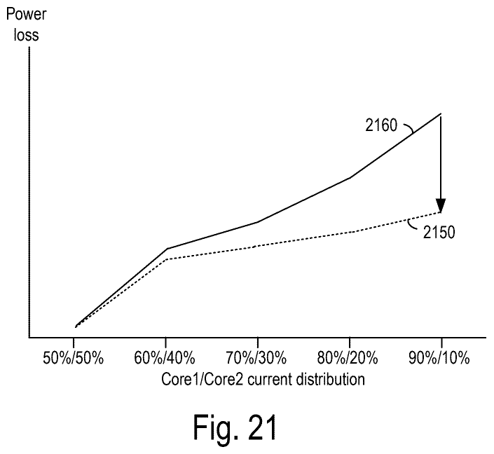

FIG. 21 depicts plots 2150 and 2160 of power loss versus Core1/Core2 current distribution with and without current steering, respectively, consistent with FIG. 20, in accordance with various embodiments. The power loss is through conductors with a 50A total current, in an example. These plots compare the I²R loss with and without current steering using the same PDN parameters as discussed above. Note that the I²R losses are equal when the two cores consume the same current, but as Core1 current increases and Core2 current decreases, the two plots start diverging. Without the current steering, the power loss shows a super linear increase (quadratic or exponential) as the load becomes more unbalanced. On the other hand, with the current steering, the increase in power loss behaves linearly, achieving an I²R loss reduction of up to 25% in the most unbalanced case of 90%/10%.

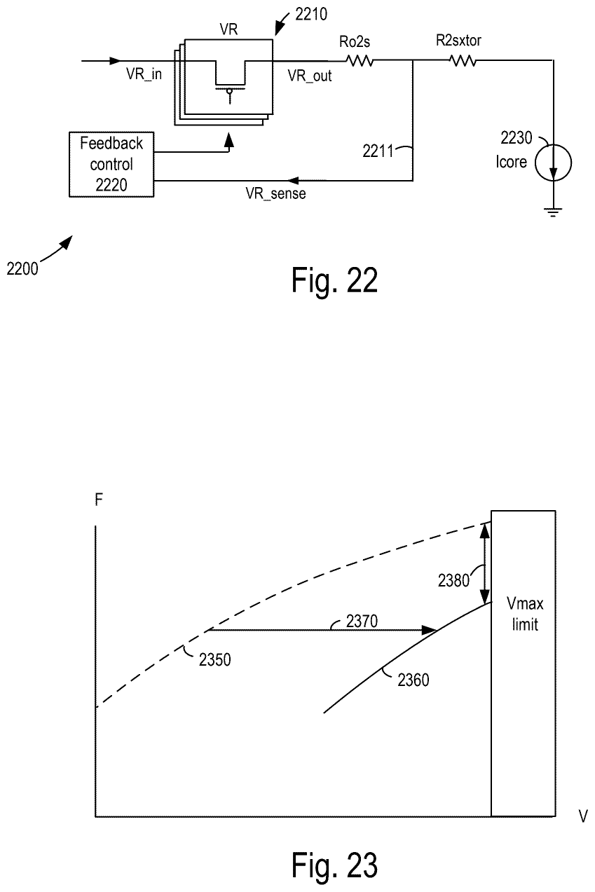

FIG. 22 depicts an example circuit 2200 representing a VR output domain, in accordance with various embodiments. The VR can be VRp or VRs, for example. The circuit includes a set of power transistors 2210 which receives VR_in as an input and provides and VR_out as an output, where feedback control 2220 regulates the voltage VR_sense to a desired value. Series resistors Ro2s and Rs2xtor are coupled between the sets of power transistors and a current sink 2230, which represents Icore. VR_sense is provided on a feedback path 2211 coupled between the two resistors.

The circuit 2200 is a representation of the VR output domain PDN at DC. There are two key parameters in this circuit: the resistance from the VR output to the sense (Rₒ₂ₛ), and the resistance from VR sense to transistor resistance (Rₛ₂ₓₜₒᵣ), also called the DC on-die load line. Note that Rₒ₂ₛ and Rₛ₂ₓₜₒᵣ are not actual physical resistors, but a representation of the DC voltage drops. In this representation, Rₒ₂ₛ will be compensated by the VR control loop by increasing the VID; the Rₛ₂ₓₜₒᵣ on the other hand cannot be compensated by the VR and will impact the voltage and frequency (V-f) curve, leading to a reduction in Fmax and degrading performance as shown in FIG. 23.

FIG. 23 depicts plots 2350 and 2360 of frequency versus voltage for ideal and actual cases, respectively, in accordance with various embodiments. The arrow 2370 represents a degradation in the V-f curve due to the on-die load line. The arrow 2380 represents the Fmax reduction from the ideal situation of zero on-die load line. A Vmax limit zone is shown at the right hand side.

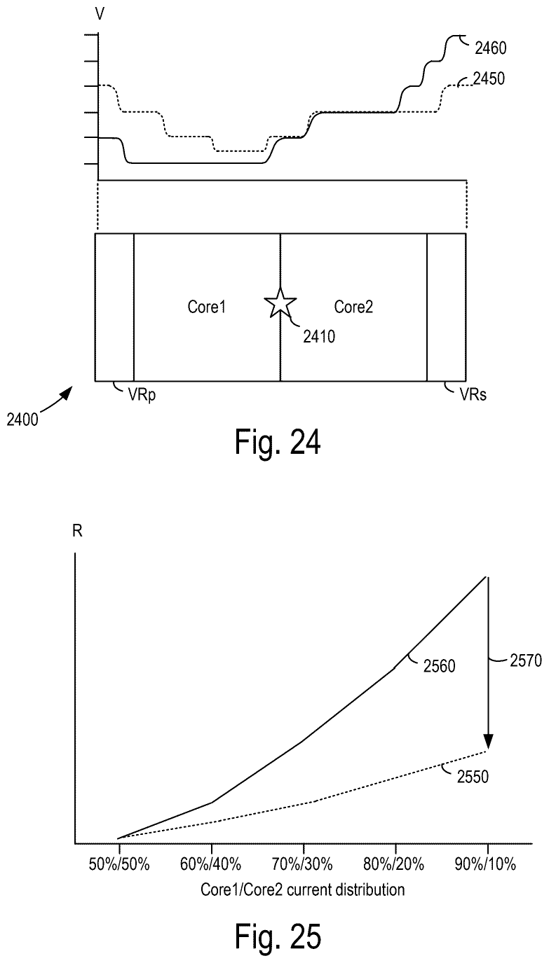

With the two identical VRs at the edges powering a dual-core module and delivering equal amounts of current and a single sense point, Rₛ₂ₓₜₒᵣ is degraded. For example, in FIG. 24, with no current steering, the voltage gradient across the domain will be larger, leading to an increase in the DC on-die load line. On the other hand, current steering will force more current through the VR near the core that draws more current, forcing more current through the smallest resistive path (R_{path,p}) and less current through the largest resistive path (R_{path,s}), reducing the voltage gradient seen across the domain and thereby decreasing the DC on-die load line.

FIG. 24 depicts a circuit 2400 including first and second cores (Core1 and Core2, respectively) powered by primary and secondary voltage regulators (VRp and VRs, respectively), with plots 2450 and 2460 of voltages with and without current steering, respectively, in accordance with various embodiments. A sense point 2410 at the border of the two cores is also depicted.

FIG. 25 depicts plots 2550 and 2560 of resistance Rₛ₂ₓₜₒᵣ versus Core1/Core2 current distribution with and without current steering, respectively, consistent with FIG. 24, in accordance with various embodiments.

FIG. 25 shows the Rₛ₂ₓₜₒᵣ vs Core1/Core2 current for the scenario described above. When the current consumed by the two cores is identical, the smallest on-die load line is achieved. However, as the Core1 current increases and Core2 current decreases, the DC on-die load line increases. Without current steering, Rₛ₂ₓₜₒᵣ shows a super linear increase, while with the current steering, the increase is closer to linear. Comparing the most extreme case (e.g., 45A in Core1 and 5A in Core2), a reduction of 33% of the Rₛₙₛ₂ₓₜₒᵣ can be achieved, as represented by the arrow 2570

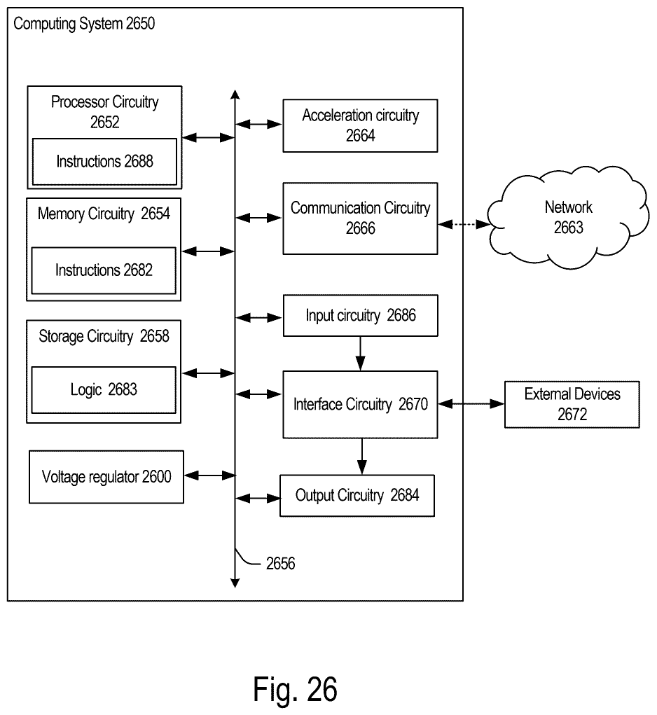

FIG. 26 illustrates an example of components that may be present in a computing system 2650 for implementing the techniques (e.g., operations, processes, methods, and methodologies) described herein.

The computing system 2650 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 2650, or as components otherwise incorporated within a chassis of a larger system. In an example implementation, the voltage regulator 2600 represents one or more of the VRs as discussed herein. In one approach, all or part of the computing system 2650 is provided in a SoP, System in Package (SiP) or a System on Chip (SoC).

The voltage regulator can provide a voltage Vout to one or more of the components of the computing system 2650. The memory circuitry 2654 may store instructions and the processor circuitry 2652 may execute the instructions to perform the functions described herein.

The system 2650 includes processor circuitry in the form of one or more processors 2652. The processor circuitry 2652 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 2652 may include one or more hardware accelerators (e.g., same or similar to acceleration circuitry 2664), which may be microprocessors, programmable processing devices (e.g., FPGA, ASIC, etc.), or the like. The one or more accelerators may include, for example, computer vision and/or deep learning accelerators. In some implementations, the processor circuitry 2652 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor circuitry 2652 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 2652 may be coupled with or may include memory/storage and may be configured to execute instructions stored in the memory/storage to enable various applications or operating systems to run on the platform 2650. The processors (or cores) 2652 is configured to operate application software to provide a specific service to a user of the platform 2650. In some embodiments, the processor(s) 2652 may be a special-purpose processor(s)/controller(s) configured (or configurable) to operate according to the various embodiments herein.

As examples, the processor(s) 2652 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 2652 may be a part of a system on a chip (SoC), System-in-Package (SiP), a multi-chip package (MCP), and/or the like, in which the processor(s) 2652 and other components are formed into a single integrated circuit, or a single package, such as the Edison™ or Galileo™ SoC boards from Intel® Corporation. Other examples of the processor(s) 2652 are mentioned elsewhere in the present disclosure.

The system 2650 may include or be coupled to acceleration circuitry 2664, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 2664 may comprise logic blocks or logic fabric and other interconnected resources that may be programmed (configured) to perform various functions, such as the procedures, methods, functions, etc. of the various embodiments discussed herein. In such implementations, the acceleration circuitry 2664 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 2652 and/or acceleration circuitry 2664 may include hardware elements specifically tailored for machine learning and/or artificial intelligence (AI) functionality. In these implementations, the processor circuitry 2652 and/or acceleration circuitry 2664 may be, or may include, an AI engine chip that can run many different kinds of AI instruction sets once loaded with the appropriate weightings and training code. Additionally or alternatively, the processor circuitry 2652 and/or acceleration circuitry 2664 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 2652 and/or acceleration circuitry 2664 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 2650 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 2650 also includes system memory 2654. Any number of memory devices may be used to provide for a given amount of system memory. As examples, the memory 2654 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 2654 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 2654 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 2658 provides persistent storage of information such as data, applications, operating systems and so forth. In an example, the storage 2658 may be implemented via a solid-state disk drive (SSDD) and/or high-speed electrically erasable memory (commonly referred to as “flash memory”). Other devices that may be used for the storage 2658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 2654 and/or storage circuitry 2658 may also incorporate three-dimensional (3D) cross-point (XPOINT) memories from Intel® and Micron®.

The memory circuitry 2654 and/or storage circuitry 2658 is/are configured to store computational logic 2683 in the form of software, firmware, microcode, or hardware-level instructions to implement the techniques described herein. The computational logic 2683 may be employed to store working copies and/or permanent copies of programming instructions, or data to create the programming instructions, for the operation of various components of system 2650 (e.g., drivers, libraries, application programming interfaces (APIs), etc.), an operating system of system 2650, one or more applications, and/or for carrying out the embodiments discussed herein. The computational logic 2683 may be stored or loaded into memory circuitry 2654 as instructions 2682, or data to create the instructions 2682, which are then accessed for execution by the processor circuitry 2652 to carry out the functions described herein. The processor circuitry 2652 and/or the acceleration circuitry 2664 accesses the memory circuitry 2654 and/or the storage circuitry 2658 over the interconnect (IX) 2656. The instructions 2682 direct the processor circuitry 2652 to perform a specific sequence or flow of actions, for example, as described with respect to flowchart(s) and block diagram(s) of operations and functionality depicted previously. The various elements may be implemented by assembler instructions supported by processor circuitry 2652 or high-level languages that may be compiled into instructions 2688, or data to create the instructions 2688, to be executed by the processor circuitry 2652. The permanent copy of the programming instructions may be placed into persistent storage devices of storage circuitry 2658 in the factory or in the field through, for example, a distribution medium (not shown), through a communication interface (e.g., from a distribution server (not shown)), over-the-air (OTA), or any combination thereof.

The IX 2656 couples the processor 2652 to communication circuitry 2666 for communications with other devices, such as a remote server (not shown) and the like. The communication circuitry 2666 is a hardware element, or collection of hardware elements, used to communicate over one or more networks 2663 and/or with other devices. In one example, communication circuitry 2666 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 2666 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 2656 also couples the processor 2652 to interface circuitry 2670 that is used to connect system 2650 with one or more external devices 2672. The external devices 2672 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 2650, which are referred to as input circuitry 2686 and output circuitry 2684. The input circuitry 2686 and output circuitry 2684 include one or more user interfaces designed to enable user interaction with the platform 2650 and/or peripheral component interfaces designed to enable peripheral component interaction with the platform 2650. Input circuitry 2686 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 2684 may be included to show information or otherwise convey information, such as sensor readings, actuator position(s), or other like information. Data and/or graphics may be displayed on one or more user interface components of the output circuitry 2684. Output circuitry 2684 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 2650. The output circuitry 2684 may also include speakers and/or other audio emitting devices, printer(s), and/or the like. Additionally or alternatively, sensor(s) may be used as the input circuitry 2684 (e.g., an image capture device, motion capture device, or the like) and one or more actuators may be used as the output device circuitry 2684 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 2650 may communicate over the IX 2656. The IX 2656 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 2656 may be a proprietary bus, for example, used in a SoC based system.

The number, capability, and/or capacity of the elements of system 2650 may vary, depending on whether computing system 2650 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 2650 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a first processor core and a second processor core; a primary voltage regulator (VR) coupled to the first processor core; and a secondary VR coupled to the second processor core, and electronically linked with the primary VR, wherein the primary VR comprises a respective set of power transistors and a respective driver coupled to the respective set of power transistors, and the secondary VR comprises a respective set of power transistors coupled to a respective set of power transistors.

Example 2 includes the apparatus of Example 1, wherein: the primary VR further comprises a respective current source coupled to the respective driver and to the respective set of power transistors; and the secondary VR further comprises a respective current source coupled to the respective driver and to the respective set of power transistors, wherein the respective current sources are configured to provide respective reference currents (which can differ in magnitude).

Example 3 includes the apparatus of Example 2, wherein the respective current source of the primary VR is to provide a reference current of Iref+/−ΔIref and the respective current source of the secondary VR is to provide a reference current of Iref−/+ΔIref.

Example 4 includes the apparatus of Example 2 or 3, wherein the primary VR further comprises a respective amplifier having inputs coupled to a source and drain of the respective set of power transistors, and a respective low-pass filter coupled to an output of the respective amplifier, and the secondary VR further comprises a respective amplifier having inputs coupled to a source and drain of the respective set of power transistors, and a respective low-pass filter coupled to an output of the respective amplifier, the apparatus further comprising; a comparison amplifier coupled to outputs of the respective low-pass filters; and an analog-to-digital control (ADC) coupled to an output of the comparison amplifier, wherein the respective current source of the primary VR is coupled to a first output of the ADC and the respective current source of the secondary VR is coupled to a second output of the ADC via an inverter.

Example 5 includes the apparatus of Example 2 or 3, wherein the primary VR further comprises a respective low-pass filter coupled to a drain of the respective set of power transistors, and the secondary VR further comprises a respective low-pass filter coupled to a drain of the respective set of power transistors, the apparatus further comprising: a comparison amplifier coupled to outputs of the respective low-pass filters; and an analog-to-digital control (ADC) coupled to an output of the comparison amplifier, wherein the respective current source of the primary VR is coupled to a first output of the ADC and the respective current source of the secondary VR is coupled to a second output of the ADC via an inverter.

Example 6 includes the apparatus of any one of Examples 1-5, wherein: the primary VR further comprises a respective Nfet calculation circuit coupled to the respective driver and to the respective set of power transistors; the secondary VR further comprises a respective Nfet calculation circuit coupled to the respective driver and to the respective set of power transistors, wherein the respective Nfet calculation circuits are configured to provide different values of Nfet for the respective drivers; and the different values indicate a number of power transistors to turn on in the respective set of power transistors of the primary VR, and a number of power transistors to turn on in the respective set of power transistors of the secondary VR.

Example 7 includes the apparatus of Example 6, wherein: the primary VR further comprises a respective amplifier having inputs coupled to a source and drain of the respective set of power transistors, and a respective low-pass filter coupled to an output of the respective amplifier, and the secondary VR further comprises a respective amplifier having inputs coupled to a source and drain of the respective set of power transistors, and a respective low-pass filter coupled to an output of the respective amplifier, the apparatus further comprising; a comparison amplifier coupled to outputs of the respective low-pass filters; and an analog-to-digital control (ADC) coupled to an output of the comparison amplifier, wherein the respective Nfet calculation circuit of the primary VR is coupled to a first output of the ADC and the respective Nfet calculation circuit of the secondary VR is coupled to a second output of the ADC, that is inverted from the first output.

Example 8 includes the apparatus of Example 6, wherein: the primary VR further comprises a respective low-pass filter coupled to a drain of the respective set of power transistors, and the secondary VR further comprises a respective low-pass filter coupled to a drain of the respective set of power transistors, the apparatus further comprising; a comparison amplifier coupled to outputs of the respective low-pass filters; and an analog-to-digital control (ADC) coupled to an output of the comparison amplifier, wherein the respective Nfet calculation circuit of the primary VR is coupled to a first output of the ADC and the respective Nfet calculation circuit of the secondary VR is coupled to a second output of the ADC, that is inverted from the first output.

Example 9 includes the apparatus of any one of Examples 2-5, wherein: the primary VR further comprises a respective Nfet calculation circuit coupled to the respective driver and to the respective set of power transistors; the secondary VR further comprises a respective Nfet calculation circuit coupled to the respective driver and to the respective set of power transistors, wherein the respective Nfet calculation circuits are configured to provide different values of Nfet for the respective drivers; and the different values indicate a number of power transistors to turn on in the respective set of power transistors of the primary VR, and a number of power transistors to turn on in the respective set of power transistors of the secondary VR.

Example 10 includes the apparatus of any one of Examples 1-9, wherein Example X includes the apparatus is provided in at least one of an integrated circuit, a System on Chip, a System in Package or a computing device.

Example 11 includes an apparatus, comprising: one or more circuits; a plurality of ganged voltage regulators (VRs) coupled to the one or more circuits, wherein the plurality of ganged VRs include respective drivers coupled to respective sets of power transistors and respective current sources; and circuitry configured to adjust reference currents provided by the respective current sources.

Example 12 includes the apparatus of Example 11, wherein the circuitry is configured to increase a reference current provided by a respective current source of a primary VR and to decrease a reference current provided by a respective current source of a secondary VR.

Example 13 includes the apparatus of Example 11 or 12, wherein the circuitry is configured to adjust reference currents provided by the respective current sources based on a difference between drain voltages of the respective sets of power transistors.

Example 14 includes the apparatus of any one of Examples 11-13, wherein the circuitry is configured to adjust reference currents provided by the respective current sources to the respective drivers based on a difference between a source-to-drain voltage of the respective set of power transistors of a primary VR and a source-to-drain voltage of the respective set of power transistors of a secondary VR.

Example 15 includes an apparatus, comprising: a first processor core and a second processor core; a primary voltage regulator (VR); and a secondary VR ganged with the primary VR, wherein the primary VR comprises a respective set of power transistors coupled to a respective driver, and the secondary VR comprises a respective set of power transistors coupled to a respective driver, wherein: the primary VR further comprises a respective Nfet calculation circuit coupled to the respective driver and to the respective set of power transistors; the secondary VR further comprises a respective Nfet calculation circuit coupled to the respective driver and to the respective set of power transistors; and the respective Nfet calculation circuits are configured to provide different values of Nfet based upon a number of power transistors to turn on in the respective set of power transistors of the primary VR and a number of power transistors to turn on in the respective set of power transistors of the secondary VR.

Example 16 includes the apparatus of Example 15, wherein: the primary VR further comprises a respective current source coupled to the respective driver and to the respective set of power transistors, to provide a respective reference current to the respective driver; and the secondary VR further comprises a respective current source coupled to the respective driver and to the respective set of power transistors, to provide a respective reference current to the respective driver, wherein the respective current sources are configured to provide respective reference currents.

Example 17 includes the apparatus of Example 15 or 16, further comprising: a high-pass filter; a scaling circuit coupled to the high-pass filter to provide ΔNfet; a summing circuit coupled to the scaling circuit to provide Nfet,p=Nfet+/−ΔNfet; and a summing circuit coupled to the scaling circuit to provide Nfet,s=Nfet−/+ΔNfet; wherein Nfet,p is the number of power transistors to turn on in the respective set of power transistors of the primary VR, and Nfet,s is the number of power transistors to turn on in the respective set of power transistors of the secondary VR.

Example 18 includes the apparatus of Example 17, further comprising: a multiplexer coupled between the high-pass filter and the summing circuits; and a comparator coupled to the multiplexer, wherein the comparator is to receive an output voltage of at least one of the primary VR or the secondary VR and to assert an asynchronous override signal at the multiplexer when the output voltage exceeds a threshold.

Example 19 includes the apparatus of Example 17 or 18, wherein the high-pass filter is to receive ΔVsd, indicating a difference between a source-to-drain voltage of the respective set of power transistors of the primary VR and a source-to-drain voltage of the respective set of power transistors of the secondary VR.

Example 20 includes the apparatus of any one of Examples 15-19, further comprising: a low-pass filter; a scaling circuit coupled to the low-pass filter to provide ΔIref; a summing circuit coupled to the scaling circuit to provide Iref,p=Iref+/−ΔIref; and a summing circuit coupled to the scaling circuit to provide Iref,s=Iref−/+ΔIref; wherein Iref,p is a respective reference current of the primary VR, and Iref,s is a respective reference current of the secondary VR.

Example 21 includes a method, comprising: receiving a respective reference current at a primary voltage regulator (VR) from a respective current source; receiving a respective reference current at a secondary VR from a respective current source; wherein: the respective current sources are configured to provide respective reference currents; the primary VR is coupled to a first processor core; the secondary VR is coupled to a second processor core, and electronically linked with the primary VR; the primary VR comprises a respective set of power transistors and a respective driver coupled to the respective set of power transistors; and the secondary VR comprises a respective set of power transistors coupled to a respective set of power transistors.

Example 22 includes the method of Example 21, further comprising, providing at the respective current source of the primary VR, a reference current of Iref+/−ΔIref, and providing, at the respective current source of the secondary VR, a reference current of Iref−/+ΔIref.

Example 23 includes the method of Example 21 or 22, further comprising providing different values of Nfet for the respective drivers, wherein the different values indicate a number of power transistors to turn on in the respective set of power transistors of the primary VR, and a number of power transistors to turn on in the respective set of power transistors of the secondary VR.

Example 24 includes an apparatus, comprising means to perform the method of any one of Examples 21-23.

Example 24 includes a machine-readable storage including machine-readable instructions which, when executed, cause a computer to implement the method of any one of Examples 21-23.

Example 25 includes a computer program comprising instructions which, when executed by a computer, cause the computer to carry out the method of any one of Examples 21-23.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a first processor core and a second processor core;
a primary voltage regulator (VR) coupled to the first processor core; and
a secondary VR coupled to the second processor core, and electronically linked with the primary VR, wherein the primary VR comprises a respective set of power transistors and a respective driver coupled to the respective set of power transistors, and the secondary VR comprises a respective set of power transistors coupled to a respective set of power transistors.

2. The apparatus of claim 1, wherein:
the primary VR further comprises a respective current source coupled to the respective driver and to the respective set of power transistors; and
the secondary VR further comprises a respective current source coupled to the respective driver and to the respective set of power transistors, wherein the respective current sources are configured to provide respective reference currents.

3. The apparatus of claim 2, wherein the respective current source of the primary VR is to provide a reference current of Iref+/−ΔIref and the respective current source of the secondary VR is to provide a reference current of Iref−/+ΔIref.

4. The apparatus of claim 2, wherein: the primary VR further comprises a respective amplifier including inputs coupled to a source and drain of the respective set of power transistors, and a respective low-pass filter coupled to an output of the respective amplifier, and the secondary VR further comprises a respective amplifier including inputs coupled to a source and drain of the respective set of power transistors, and a respective low-pass filter coupled to an output of the respective amplifier, the apparatus further comprising;
a comparison amplifier coupled to outputs of the respective low-pass filters; and
an analog-to-digital control (ADC) coupled to an output of the comparison amplifier, wherein the respective current source of the primary VR is coupled to a first output of the ADC and the respective current source of the secondary VR is coupled to a second output of the ADC via an inverter.

5. The apparatus of claim 2, wherein the primary VR further comprises a respective low-pass filter coupled to a drain of the respective set of power transistors, and the secondary VR further comprises a respective low-pass filter coupled to a drain of the respective set of power transistors, the apparatus further comprising:
a comparison amplifier coupled to outputs of the respective low-pass filters; and
an analog-to-digital control (ADC) coupled to an output of the comparison amplifier, wherein the respective current source of the primary VR is coupled to a first output of the ADC and the respective current source of the secondary VR is coupled to a second output of the ADC via an inverter.

6. The apparatus of claim 1, wherein:
the primary VR further comprises a respective Nfet calculation circuit coupled to the respective driver and to the respective set of power transistors;
the secondary VR further comprises a respective Nfet calculation circuit coupled to the respective driver and to the respective set of power transistors, wherein the respective Nfet calculation circuits are configured to provide different values of Nfet for the respective drivers; and
the different values indicate a number of power transistors to turn on in the respective set of power transistors of the primary VR, and a number of power transistors to turn on in the respective set of power transistors of the secondary VR.

7. The apparatus of claim 6, wherein the primary VR further comprises a respective amplifier having inputs coupled to a source and drain of the respective set of power transistors, and a respective low-pass filter coupled to an output of the respective amplifier, and the secondary VR comprises a respective amplifier including inputs coupled to a source and drain of the respective set of power transistors, and a respective low-pass filter coupled to an output of the respective amplifier, the apparatus further comprising:
a comparison amplifier coupled to outputs of the respective low-pass filters; and
an analog-to-digital control (ADC) coupled to an output of the comparison amplifier, wherein the respective Nfet calculation circuit of the primary VR is coupled to a first output of the ADC and the respective Nfet calculation circuit of the secondary VR is coupled to a second output of the ADC, that is inverted from the first output.

8. The apparatus of claim 6, wherein the primary VR further comprises a respective low-pass filter coupled to a drain of the respective set of power transistors, and the secondary VR comprises a respective low-pass filter coupled to a drain of the respective set of power transistors, the apparatus further comprising:
a comparison amplifier coupled to outputs of the respective low-pass filters; and
an analog-to-digital control (ADC) coupled to an output of the comparison amplifier, wherein the respective Nfet calculation circuit of the primary VR is coupled to a first output of the ADC and the respective Nfet calculation circuit of the secondary VR is coupled to a second output of the ADC, that is inverted from the first output.

9. The apparatus of claim 2, wherein:
the primary VR further comprises a respective Nfet calculation circuit coupled to the respective driver and to the respective set of power transistors; and
the secondary VR comprises a respective Nfet calculation circuit coupled to the respective driver and to the respective set of power transistors, wherein the respective Nfet calculation circuits are configured to provide different values of Nfet for the respective drivers; and
the different values indicate a number of power transistors to turn on in the respective set of power transistors of the primary VR, and a number of power transistors to turn on in the respective set of power transistors of the secondary VR.

10. The apparatus of claim 1, wherein the apparatus is provided in at least one of an integrated circuit, a System on Chip, a System in Package or a computing device.

11. An apparatus, comprising:
one or more circuits;
a plurality of ganged voltage regulators (VRs) coupled to the one or more circuits, wherein the plurality of ganged VRs includes respective drivers coupled to respective sets of power transistors and respective current sources; and
circuitry configured to adjust reference currents provided by the respective current sources.

12. The apparatus of claim 11, wherein the circuitry is configured to increase a reference current provided by a respective current source of a primary VR and to decrease a reference current provided by a respective current source of a secondary VR.

13. The apparatus of claim 11, wherein the circuitry is configured to adjust reference currents provided by the respective current sources based on a difference between drain voltages of the respective sets of power transistors.

14. The apparatus of claim 11, wherein the circuitry is configured to adjust reference currents provided by the respective current sources to the respective drivers based on a difference between a source-to-drain voltage of the respective set of power transistors of a primary VR and a source-to-drain voltage of the respective set of power transistors of a secondary VR.

15. An apparatus, comprising:
a first processor core and a second processor core;
a primary voltage regulator (VR); and
a secondary VR electronically linked with the primary VR, wherein the primary VR comprises a respective set of power transistors coupled to a respective driver, and the secondary VR comprises a respective set of power transistors coupled to a respective driver, wherein:
the primary VR further comprises a respective Nfet calculation circuit coupled to the respective driver and to the respective set of power transistors;
the secondary VR further comprises a respective Nfet calculation circuit coupled to the respective driver and to the respective set of power transistors; and
the respective Nfet calculation circuits are configured to provide different values of Nfet based upon a number of power transistors to turn on in the respective set of power transistors of the primary VR and a number of power transistors to turn on in the respective set of power transistors of the secondary VR.

16. The apparatus of claim 15, wherein:
the primary VR further comprises a respective current source coupled to the respective driver and to the respective set of power transistors, to provide a respective reference current to the respective driver; and
the secondary VR further comprises a respective current source coupled to the respective driver and to the respective set of power transistors, to provide a respective reference current to the respective driver, wherein the respective current sources are configured to provide respective reference currents.

17. The apparatus of claim 15, further comprising:
a high-pass filter;
a scaling circuit coupled to the high-pass filter to provide ΔNfet;
a summing circuit coupled to the scaling circuit to provide Nfet,p=Nfet+/−ΔNfet; and
a summing circuit coupled to the scaling circuit to provide Nfet,s=Nfet−/+ΔNfet;
wherein Nfet,p is the number of power transistors to turn on in the respective set of power transistors of the primary VR, and Nfet,s is the number of power transistors to turn on in the respective set of power transistors of the secondary VR.

18. The apparatus of claim 17, further comprising:
a multiplexer coupled between the high-pass filter and the summing circuits; and
a comparator coupled to the multiplexer, wherein the comparator is to receive an output voltage of at least one of the primary VR or the secondary VR and to assert an asynchronous override signal at the multiplexer when the output voltage exceeds a threshold.

19. The apparatus of claim 17, wherein the high-pass filter is to receive ΔVsd, indicating a difference between a source-to-drain voltage of the respective set of power transistors of the primary VR and a source-to-drain voltage of the respective set of power transistors of the secondary VR.

20. The apparatus of claim 15, further comprising:
a low-pass filter;
a scaling circuit coupled to the low-pass filter to provide ΔIref;
a summing circuit coupled to the scaling circuit to provide Iref,p=Iref+/−ΔIref; and
a summing circuit coupled to the scaling circuit to provide Iref,s=Iref−/+ΔIref;
wherein Iref,p is a respective reference current of the primary VR, and Iref,s is a respective reference current of the secondary VR.
